(19) United States
(12) Patent Application Publication
(10) Pub. No.: US 2017/0329440 A1
(43) Pub. Date: Nov. 16, 2017

(54) CONTROLLER PREMONITION USING CAPACITIVE SENSING

(71) Applicant: CIRQUE CORPORATION, Salt Lake City, UT (US)

(72) Inventors: Ethan Sturm, Salt Lake City, UT (US); Steven H. Baker, American Fork, UT (US); Paul Vincent, Kaysville, UT (US); David C. Taylor, West Jordan, UT (US)

(21) Appl. No.: 15/594,309

(22) Filed: May 12, 2017

Related U.S. Application Data
(60) Provisional application No. 62/335,557, filed on May 12, 2016.

(51) Int. Cl. G06F 3/044; G06T 19/00; A63F 13/21; A63F 13/28

(52) U.S. Cl. CPC G06F 3/044; A63F 13/28; G06T 19/006; A63F 13/21; G06F 2203/04101; A63F 2300/8082

(57) ABSTRACT

A system and method for providing a virtual reality game controller with improved functionality by providing capacitive touch and proximity sensors on the controller to enable additional feedback to the user such that interaction with a physical object such as a game controller may be translated into interaction with a virtual tool in a virtual environment such as providing a visual indication in the virtual environment that a finger or thumb is approaching a button of a physical game controller.

### BACKGROUND OF THE INVENTION

### Field of the Invention

This invention relates generally to game controllers and touch sensors. Specifically, the invention pertains to a system and method for providing a virtual reality game controller with improved functionality by providing capacitive touch and proximity sensors on the controller to enable additional feedback to the user that is particularly useful in a virtual reality environment.

### Description of Related Art

There are several designs for capacitance sensitive touch sensors which may take advantage of a system and method for providing capacitive touch sensors on the controller to enable additional feedback to the user. It is useful to examine the underlying technology of the touch sensors to better understand how any capacitance sensitive touchpad can take advantage of the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Using an equation that compares the magnitude of the two signals measured then performs pointing object position determination.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention. The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing.

An environment where a touch sensor such as the one described above may be used is in the growing area of virtual reality. Virtual reality environments present unique user interaction situations. For example, a user may have a device placed on the user's head, or a head-mounted display (HMD), which may cover the eyes and present a virtual reality environment. The user may also have headphones to enhance the virtual reality experience with the addition of audio. However, there may be a disconnect between the virtual reality that the user is experiencing through sight and sound, and the actual physical area in which the user is located. This disconnect may be apparent to the user because the purpose of the virtual reality environment may be to present objects and sounds to the user that do not actually exist, or at least do not exist in the immediate physical environment.

The experience of wearing an HMD may be very disconcerting to users because the user is not typically able to see their own body, arms, legs, feet or hands. This lack of visual feedback of a user's own body or extremities may be detrimental to the experience of the user and detract from the virtual environment because a user may be limited to only having tactile feedback from the physical object. Accordingly, it would be advantageous to provide additional feedback to a user when manipulating a physical object that is also being represented in the virtual environment as a virtual tool.

This disconnect from the physical environment may not be obvious when discussing a virtual reality environment until it is realized that the customary visual cues or feedback of where a user is located in relation to his environment are missing. These clues include but are not limited to the user being able to see their own body or objects that are being held with hands. The lack of visual clues to the location of the user's own arms, hands, legs and feet may cause the user to stumble or awkwardly reach out to feel for objects.

Accordingly, the virtual reality experience of the user may be enhanced if some physical objects in the physical environment are represented as virtual objects in the virtual environment. For example, it is already possible for physical objects to be represented in the virtual environment. Such an object may be a hand-held gaming controller, or just game controller. However, that does not mean that the virtual object must appear exactly the same as the physical object exists in the physical environment. The virtual object may be manipulated by programming so that it appears different in the virtual environment, but still be capable of interaction with the user. Accordingly, it would be an advantage over the prior art to be able to enhance interaction between a user and a virtual object that is a representation of at least a portion of a physical object, or vice versa.

Interaction between a user and a virtual object may begin with what the user is able to see in the virtual environment. For example, a user may want to press a button or push on a dial on a game controller. In the physical environment, the task is simple because the user can see a thumb or finger move closer to the game controller and visually guide the thumb or finger to the desired location. However, this visual feedback may be lacking in the virtual environment because it may be very difficult to represent a user's hands and fingers in the virtual environment. Accordingly, it would be an advantage over the prior art to be able to provide a visual clue to the user in the virtual environment that can assist the user to visually guide a body part such as a hand, finger, thumb, arm leg, or foot to a desired location in the virtual environment, even though the body part is not visible to the user in the virtual environment.

Use of the term “touch sensor” throughout this document may be used interchangeably with “capacitive touch sensor”, “capacitive sensor”, “capacitive touch and proximity sensor”, “proximity sensor”, “touch and proximity sensor”, “touch panel”, “touchpad” and “touch screen”. Furthermore, any use of the term “game controller” may be used interchangeably with the term “virtual reality game controller”.

### BRIEF SUMMARY OF THE INVENTION

In a first embodiment, the present invention is a system and method for providing a virtual reality game controller with improved functionality by providing capacitive touch and proximity sensors on the controller to enable additional feedback to the user such that interaction with a physical object such as a game controller may be translated into interaction with a virtual tool in a virtual environment such as providing a visual indication in the virtual environment that a finger or thumb is approaching a button of a physical game controller.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of operation of a touchpad that is found in the prior art, and which is adaptable for use in the present invention.

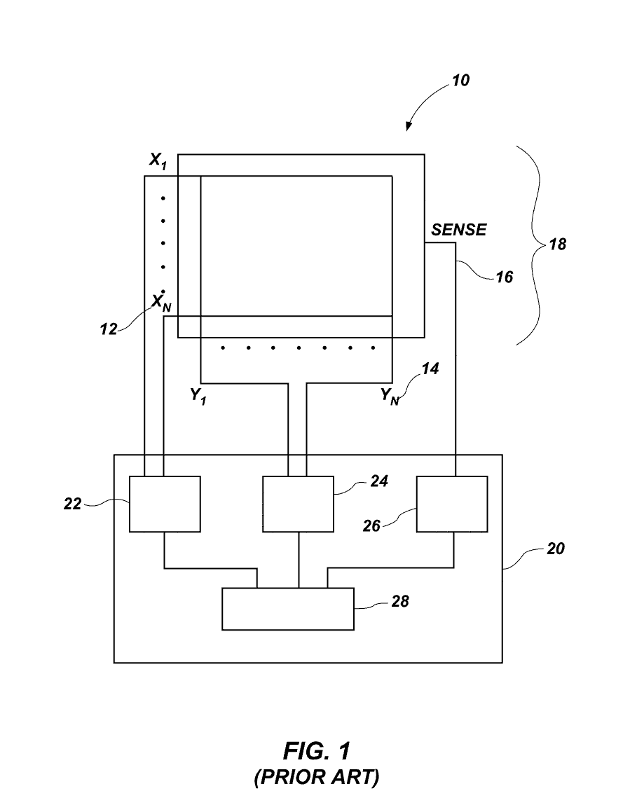

FIG. 2 is an elevational view of two physical game controllers that may be modified to include the present invention.

FIG. 3A is a top view of a touch sensor on the physical game controller.

FIG. 3B is a top view of a keypad on the virtual tool that is the same shape and size and location as the touch sensor on the virtual tool.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

A first embodiment of the invention is to provide visual clues to the user that enhance interaction between the user and a virtual object that represents at least a portion of a physical object. While the examples given below are directed to a handheld object, the first embodiment should not be considered as limited to such a device.

It should also be understood that whenever a virtual object is being discussed, the virtual object represents all or a portion of a physical object that the user may also touch in the physical environment. The physical object may appear differently in the virtual environment or it may appear the same. What is important is that interaction between the user and an object in the physical environment is being represented in some manner or translated to the virtual environment.

For example, a user may want to use a virtual tool in the virtual environment. It may be desirable for the user to interact with a physical object to more easily perform interaction with the virtual tool. In other words, the physical object may be represented in the virtual environment, and manipulation of the physical object may be translated into interaction with the virtual tool in the virtual environment.

Beginning with the understanding that the user's own body parts are not being represented in the virtual environment, the first embodiment is directed to providing visual feedback to the user that indicate how the user is going to interact with a virtual object.

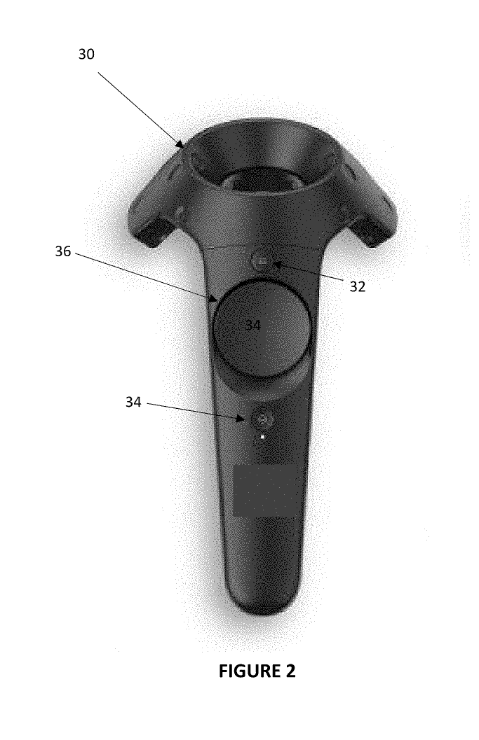

FIG. 2 is provided as a perspective view of a physical game controller 30. The game controller 30 may be represented in the virtual environment as a handheld device. However, it should be understood that the game controller 30 may appear as a different object in the virtual environment. This virtual object may be similar or different in shape, size, color, texture or any other visual attribute relative to the physical game controller 30. The virtual object may not even show a grip or hand hold where a user is actually holding the game controller 30. What is important is that the user is able to interact the game controller, and the game controller is represented in the virtual environment.

A first feature of the first embodiment is that the object, in this example the game controller 30, may include one or more sensors disposed within and/or on the surface of the game controller. A second feature is that the game controller 30 also be detectable and trackable by sensors such that it is present in the virtual environment as a virtual object. The virtual object may be any object that can be represented in the virtual environment and should not be considered to be limited to the size, shape or any other visual attribute of the physical game controller 30.

Because the physical game controller 30 may appear in a virtual environment as any object, it is useful to understand what those objects might be. For example, the game controller 30 may be a weapon, a tool or any object that the user may interact with. Because of the movable nature of the game controller 30, it is understandable that the virtual object might also be movable. Some good examples of a virtual object include, but should not be considered as limited to, a flashlight, a paint brush, a gun or any other desired object.

The physical game controller 30 may have physical features that may or may not be duplicated in the virtual environment. For example, consider a trigger mechanism, a button, a switch, a joystick, a stick pad or any other physical feature that may be present on the physical game controller 30. These physical features may be used to provide input to the virtual environment. For example, a trigger mechanism may function as a trigger on a weapon or a s a trigger on a spray gun.

What may be apparent is that while a trigger may not be difficult to locate because the user's finger may rest on the trigger in the physical environment, other features such as buttons or touchpads may be more difficult because the user may not already have a finger or thumb on the feature. Furthermore, even if the trigger mechanism on the physical game controller functions as a trigger on the virtual tool, there may be some disconnect between a physical object and its virtual representation in the virtual environment. For example, they may or not be precisely in the same place.

There may be many interactive experiences in the virtual environment that some users may have a more difficult time dealing with. Therefore, it may be desirable to provide more feedback to the user to assist the interactive process. In the first embodiment of the present invention, capacitive sensing on the game controller 30 may be used to provide users with visual feedback inside the virtual environment that represent physical interaction between a user and the game controller.

The physical game controller 30 may include a first button 32, a second button 34, and a pad or dial 36. The physical game controller 30 should not be considered to be limited to the specific number of buttons or pads, or the arrangement as shown, but are shown for illustration purposes only.

In the first embodiment, the game controller 30 may use one or more capacitive sensors that are capable of proximity detection of a user's detectable extremities such as hands, fingers or thumbs as they approach the capacitive sensors disposed in or on the physical game controller. By using proximity detection, the capacitive sensors may be able to detect not just the touch of a feature on the game controller, but more importantly, the approach of the detectable extremities toward the feature. This information regarding the approach of the detectable extremities may then be used to provide the desired visual feedback to the user in the virtual environment.

In the first embodiment, the visual feedback may provide a “premonition” or “preview” to the user in advance of the user actually touching a button or other feature of the game controller 30. In other words, in much the same way as the user may guide a finger toward a button by watching the finger approach the button, the user may be given visual feedback that indicates to the user that the detectable extremity is approaching the feature.

The specific type of visual feedback may include any visual indicator. For example, the visual feedback may be a change in intensity of lighting of a feature on the virtual object. As shown in FIG. 2, the physical game controller 30 on the left has a button 32. The button 32 may not be illuminated when no detectable object is near it in the virtual environment. However, when a user's finger or other detectable object approaches the button 32 on the physical game controller 30, the button 32 may be illuminated in the virtual environment by a red ring around the button on the physical game controller.

Alternatively, the entire button 32 may be change from no illumination and gradually become brighter until contact is made on the physical game controller 30. Thus, any visual indicator regarding light intensity may be used.

Another visual indicator may be a series of concentric rings around the button 32. The number of concentric rings that are glowing around the button 32 may increase until all the concentric rings are lit when the button is touched on the physical game controller 30.

One of the advantages of using a visual indicator in the virtual environment to illuminate a button or other feature on the virtual controller is that because the illumination is virtual, there are no physical limitations that must be dealt with. The illumination is only a programmable feature of the feature being illuminated, so there are no limitations as to the location, size, or intensity of the illumination. Thus, illumination may extend beyond a feature or button that is being approached. For example, the entire virtual object may be caused to glow.

What is helpful to remember is that what may be seen by the user in the virtual environment may not be the same game controller that is being represented virtually, but some other object having an interactive feature on the virtual tool in the same location as the button 32 on the physical game controller 30. The button 32 or feature would then be modified or highlighted or illuminated in some way so that some visual manifestation of the approach of the user's finger toward the button 32 would occur and be visible to the user if the user is looking at the virtual object in the virtual environment.

Some visual indicators or modifications that could occur in the virtual environment to the virtual object or to a portion of the virtual object include, but should not be considered as limiting of all the different changes that can take place to provide a visual clue to the user, a change in the size of the virtual object, a change in coloring, a change in illumination, a change in movement or a feature of the virtual object and the creation of another virtual object. These changes may take place on or adjacent to the virtual object, and may involve the entire virtual object or just a portion of the virtual object.

While the first embodiment is directed to visual indicators that may be seen by the user in the virtual environment, in a second embodiment of the invention, the feedback given to the user may also include tactile feedback. For example, the physical game controller 30 may vibrate at different rates to indicate how close a detectable extremity is to the buttons 32.

In a third embodiment of the present invention, it may not be the approach of an object toward a capacitive sensor that may cause a change in the virtual environment. Other actions that the user may do with the physical game controller 30 may include but should not be considered as limited to, a change in grip or a change in force applied to the physical game controller. Accordingly, selected portions of the physical game controller 30 may include proximity sensing of the entire game controller. Likewise, selected portions of the physical game controller 30 may include touch sensing of the entire game controller.

It may be possible to provide an image of a user's hand on the physical game controller 30 for more advanced positional information in the virtual environment. Thus, it may be possible to determine where each finger is resting on the game controller 30. Sensing may be further modified to accomplish grip force sensing for certain games or applications.

It should be understood that all of the embodiments of the present invention may make it possible to perform detection of a finger that may be hovering over a larger capacitive sensor so that it may be possible to determine where the finger will make contact when contact is made. Thus, the user may know where a hand or portions of a hand will make contact with a physical game controller 30 before contact is actually made.

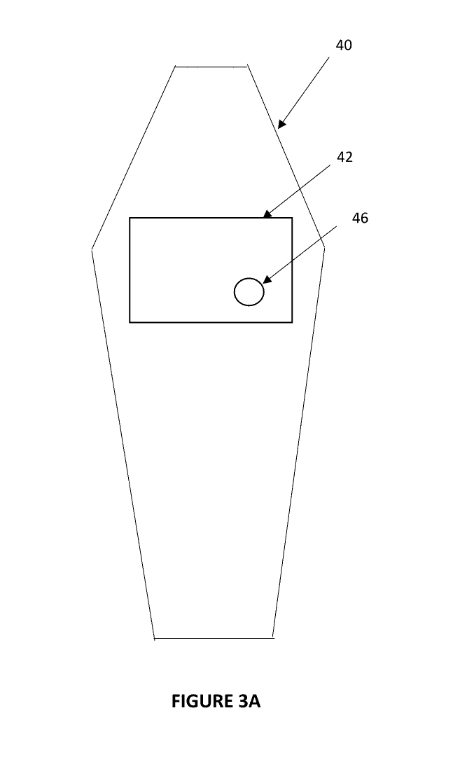

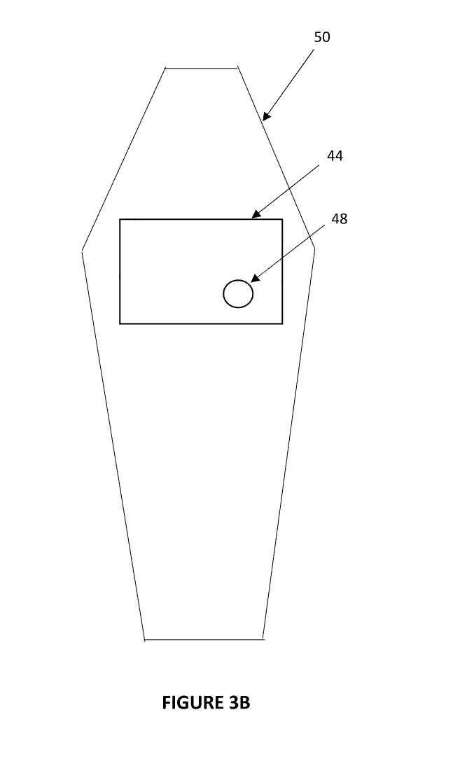

In at least one embodiment of the present invention, FIG. 3A shows a top view of a rectangular touch sensor 42 that is disposed on a physical game controller 40 that is different in shape from the first game controller 30 shown in FIG. 2. The shape of the physical game controller 40 may be changed as desired so that the game controller 40 more closely fits the shape of the object that is typically used in the physical environment. For example, while a game controller that is gripped like a weapon may be more useful when the virtual object is representing a weapon, a game controller in the shape of a cylinder or elongated object may be more useful when the game controller represents a flashlight or other similar longer object.

FIG. 3B shows a top view of a different game controller 50 from the game controller 40 shown in FIG. 3A, but with a physical keypad 44 with a plurality of individual keys, the keypad being located on a top surface of the game controller. In this example, the rectangular touch sensor 42 of the game controller 40 and the keypad 44 of the game controller 50 are located in approximately the same locations on a physical game controller. Thus, game controllers with similar overall shapes may be equipped with different types of physical features.

FIG. 3A also shows the location 46 of a finger that is hovering over but not making physical contact with the rectangular touch sensor 42 on the physical game controller 40. The location 46 is the position of the fingertip that is perpendicular to the plane of the rectangular touch sensor 42. Similarly, FIG. 3B shows the location 48 on the keypad 44 over which the fingertip is hovering over the game controller 50.

A visual indicator may be displayed in the virtual environment on the virtual keypad in order to indicate the location of the finger as it approaches the physical keyboard 44. The visual indicator may be any of the previously mentioned indicators such as a change in the size of the virtual object, a change in coloring of the virtual object, a change in illumination of the virtual object, movement of the virtual object and the creation of another virtual object, or any other visual indicator. For example, one visual indicator may be that a key over which the fingertip is hovering could actually become larger and extend out from the virtual keyboard in much the same manner as keys do on virtual keyboards of portable electronic appliances such as mobile phones.

Because the shape and dimensions of the rectangular touch sensor 42 and the keypad 44 are approximately the same, the user may be able to operate the game controller 40 as if it had a keypad in place of the touch sensor 42. In other words, the physical keys of the keypad 44 on game controller 50 could be replace by virtual keys and thus use the game controller 40 as if it had a keypad. The user may move a fingertip over the rectangular touch sensor 42 until the finger is hovering over a location on a virtual keypad that the user wants to touch in the virtual environment. Then the user may bring the finger down to make contact with the rectangular touch sensor 42, and cause the corresponding key on a virtual keypad to be touched in the virtual environment.

While making the size and shape of the rectangular touch sensor 42 and the keypad 44 approximately the same may be useful, it is not necessary to have this similarity in order to translate actions with the physical game controller 40 to be translated into actions in the virtual environment. This example was for illustration purposes only and may be varied as described above.

A method of using the first embodiment to provide feedback to a user in a virtual reality environment would be as follows. The first steps would be to provide a virtual environment that is visible to the user, a physical game controller, and a virtual object that represents the physical game controller but within the virtual environment.

The next step is to dispose at least one proximity sensor on the physical game controller, wherein the at least one proximity sensor will detect an object approaching the at least one proximity sensor before contact is made. The next step is to actual detect an object approaching the at least one proximity sensor on the physical game controller, and to then provide a visual indicator in the virtual environment that the object is approaching the physical game controller. In the first embodiment, the visual indicator may be provided on the virtual object itself that the object is approaching the physical game controller. Furthermore, the visual indicator may be changed to thereby indicate a distance of the object from the physical game controller.

Features may be disposed on the physical game controls that are activated by touch and deactivated when the touch is withdrawn. By disposing a proximity sensor in the feature, the feature may then determine when an object is approaching and indicate the distance of the object to the user by some visual indicator in the virtual environment.

The features may be selected from, but should not be considered as limited to a button, a trigger, a keyboard, a pad, and a dial. The visual indicators may be selected from, but should not be considered as limited to, the group of visual indicators comprised of an illuminated surface, an illuminated ring on a surface, and a plurality of concentric illuminated rings on a surface of the virtual object.

In addition, distance of the object from the physical game controller may be indicated by changing an intensity of illumination of the visual indictor in order to indicate the distance of the object from the physical game controller.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for providing feedback to a user in a virtual reality environment, said method comprising the steps of:
providing a virtual environment that is visible to the user;
providing a physical game controller;
providing a virtual object that represents the physical game controller but within the virtual environment;
disposing at least one proximity sensor on the physical game controller, wherein the at least one proximity sensor will detect an object approaching the at least one proximity sensor before contact is made;
detecting an object approaching the at least one proximity sensor on the physical game controller; and
providing a visual indicator in the virtual environment that the object is approaching the physical game controller.

2. The method as defined in claim 1 wherein the method further comprises providing the visual indicator on the virtual object that the object is approaching the physical game controller.

3. The method as defined in claim 2 wherein the method further comprises changing the visual indicator to thereby indicate a distance of the object from the physical game controller.

4. The method as defined in claim 3 wherein the method further comprises:
1) creating a first feature on the physical game controller that is activated by touch and deactivated when touch is withdrawn; and
2) disposing the at least one proximity sensor on the first feature.

5. The method as defined in claim 4 wherein the method further comprises selecting the first feature from the plurality of features comprised of a button, a trigger, a keyboard, a pad, and a dial.

6. The method as defined in claim 5 wherein the method further comprises providing a plurality of features on the physical game controller.

7. The method as defined in claim 3 wherein the method further comprises selecting the visual indicator from the group of visual indicators comprised of an illuminated surface, an illuminated ring on a surface, and a plurality of concentric illuminated rings on a surface.

8. The method as defined in claim 7 wherein the method further comprises changing an intensity of illumination of the visual indictor in order to indicate the distance of the object from the physical game controller.

9. The method as defined in claim 7 wherein the method further comprises changing the number of the concentric illuminated rings that are illuminated in order to indicate the distance of the object from the physical game controller.

10. The method as defined in claim 2 wherein the method further comprises providing a location of the object that is approaching the physical game controller on the virtual object by using the visual indicator to show the location on the virtual object that is perpendicular to the object relative to the physical game controller.

11. A system for providing feedback to a user in a virtual reality environment, said system comprised of:
a virtual environment that is visible to the user;
a physical game controller;
a virtual object that represents the physical game controller but within the virtual environment;
at least one proximity sensor disposed on the physical game controller, wherein the at least one proximity sensor will detect an object approaching the at least one proximity sensor before contact is made; and
a visual indicator in the virtual environment that indicates that the object is approaching the physical game controller.

12. The system as defined in claim 11 wherein the system is further comprised of the visual indicator being disposed on the virtual object.

13. The system as defined in claim 12 wherein the system is further comprised of the visual indicator indicating a distance of the object from the physical game controller.

14. The system as defined in claim 13 wherein the system is further comprised of a first feature disposed on the physical game controller that is activated by touch and deactivated when touch is withdrawn, wherein the at least one proximity sensor is disposed on the first feature.

15. The system as defined in claim 14 wherein the system is further comprised of selecting the first feature from the plurality of features comprised of a button, a trigger, a keyboard, a pad, and a dial.

16. The system as defined in claim 15 wherein the system is further comprised of a plurality of features disposed on the physical game controller.

17. The system as defined in claim 13 wherein the system is further comprised of selecting the visual indicator from the group of visual indicators comprised of an illuminated surface, an illuminated ring on a surface, and a plurality of concentric illuminated rings on a surface.

18. The system as defined in claim 17 wherein the system is further comprised of the visual indictor changing an intensity of the illumination in order to indicate the distance of the object from the physical game controller.

19. A method for providing feedback to a user in a virtual reality environment, said method comprising the steps of:
providing a virtual environment that is visible to the user;
providing a physical game controller;
providing a virtual object that represents the physical game controller but within the virtual environment;
disposing at least one proximity sensor on the physical game controller, wherein the at least one proximity sensor will detect an object approaching the at least one proximity sensor before contact is made;
detecting an object approaching the at least one proximity sensor on the physical game controller; and
providing a visual indicator in the virtual environment that the object is approaching the physical game controller, and changing the visual indicator to thereby indicate a distance of the object from the physical game controller.
